(19) United States
(12) Patent Application Publication
(10) Pub. No.: US 2005/0137756 A1
(43) Pub. Date: Jun. 23, 2005

(54) Vehicle driving support system and vehicle driving support program

(75) Inventor: Hiroshi Takahashi, Tokyo (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 11/012,159

(22) Filed: Dec. 16, 2004

(30) Foreign Application Priority Data
Dec. 18, 2003 (JP) P 2003-420837
Sep. 14, 2004 (JP) P 2004-266762

(51) Int. Cl. G06F 17/00

(52) U.S. Cl. 701/1; 340/439

(57) ABSTRACT

A surrounding area observing device detects a traffic flow around a vehicle, a traffic flow simulator simulates a virtual traffic flow based on the detected traffic flow, and a simulation result evaluating device predicts an approaching traffic flow around the vehicle based on the simulation result. Thus, traffic conditions in a location unobservable from the vehicle can be indicated to a driver with a more simple system configuration.

### BACKGROUND OF THE INVENTION

The present invention relates to a vehicle driving support system and a vehicle driving support program for giving support to a vehicle driver in making decisions of his or her driving behavior by predicting and indicating a traffic condition in a location unobservable from a vehicle. In particular, the present invention relates to a technique by which a traffic condition in a location unobservable from a vehicle can be predicted with a simple system configuration.

There has been known systems which collect traffic flow information by using equipment, such as a beacon or monitoring cameras, which are distributively located on a network of roads, and provide a traffic flow simulation on the basis of the collected traffic flow information, as disclosed in Japanese Patent Application Laid-Open No. 2001-195682. Such a system can assist a driver in making decisions of his or her driving behavior by presenting information about approaching traffic conditions, including the time required to reach a predetermined spot or the state of traffic congestion. The term “traffic flow” described herein means behavior of vehicles traveling on the network of roads and, more specifically, can be defined by parameters of positions or speeds of the vehicles traveling on the network of roads.

### SUMMARY OF THE INVENTION

The configuration of the conventional system, however, requires a large number of monitoring apparatuses and an information processor capable of processing enormous volumes of data collected by those monitoring apparatuses in order to predict and indicate approaching traffic conditions. Therefore, it is difficult to predict and indicate traffic conditions in a location unobservable from a vehicle with a simple system configuration. Even considering future proliferation and growth of road-to-vehicle communication technology or inter-vehicle communication technology, it is still technically and economically difficult to comprehensively detect traffic conditions in a location unobservable from a vehicle.

The present invention has therefore been proposed to solve the problem in the conventional system, and has an object to provide a driving support system and a driving support program both of which are capable of predicting and indicating traffic conditions in a location unobservable from a vehicle with a system configuration that is simpler than the conventional one.

In order to achieve the above object, the driving support system according to the present invention detects the current traffic flow around a vehicle (subject vehicle), simulates a virtual traffic flow based on the detected current traffic flow, and predicts an approaching traffic flow around the subject vehicle based on the simulated virtual traffic flow. Furthermore, in order to achieve the above object, the driving support program according to the present invention makes a computer execute a step of detecting the current traffic flow around of a vehicle (subject vehicle), a step of simulating a virtual traffic flow around the subject vehicle based on the detected current traffic flow, and a step of predicting an approaching traffic flow around the subject vehicle based on the simulated virtual traffic flow.

### BRIEF DESCRIPTION OF THE DRAWINGS

FIG. 1 is a block diagram showing a configuration of a driving support system according to a first embodiment of the present invention;

FIG. 2 is a diagram showing areas taken by cameras of FIG. 1;

FIG. 3 is a flowchart showing a flow of driving support processing executed by the driving support system of FIG. 1;

FIG. 4 is a flowchart showing a continuation of the driving support processing of FIG. 3;

FIG. 5 is a diagram showing an example of a map of surrounding area generated by a surrounding area observing device of FIG. 1;

FIGS. 6A and 6B are diagrams exemplarily showing simulation areas generated by a simulation parameter estimating device of FIG. 1;

FIG. 7 is a diagram showing an example of a virtual obstacle placed by a virtual obstacle placing device of FIG. 1;

FIG. 8 is a diagram showing an example of a method of determining a position where the obstacle of FIG. 7 is placed;

FIGS. 9A and 9B are diagrams exemplarily showing maps of surrounding areas obtained based on a current traffic flow and a virtual traffic flow, respectively;

FIG. 10 is a diagram for explaining advantages achieved by the driving support system of FIG. 1;

FIG. 11 is a block diagram showing a configuration of a driving support system according to a second embodiment of the present invention;

FIG. 12 is a flowchart showing a flow of driving support processing executed by the driving support system of FIG. 11;

FIG. 13 is a block diagram showing a configuration of a driving support system according to a third embodiment of the present invention; and

FIG. 14 is a flowchart showing a flow of driving support processing executed by the driving support system of FIG. 13.

### DETAILED DESCRIPTION OF THE PREFERRED EMBODIMENTS

With reference to the accompanying drawings, configurations and operations of driving support systems according to first to third embodiments of the present invention will be described below in detail.

### First Embodiment

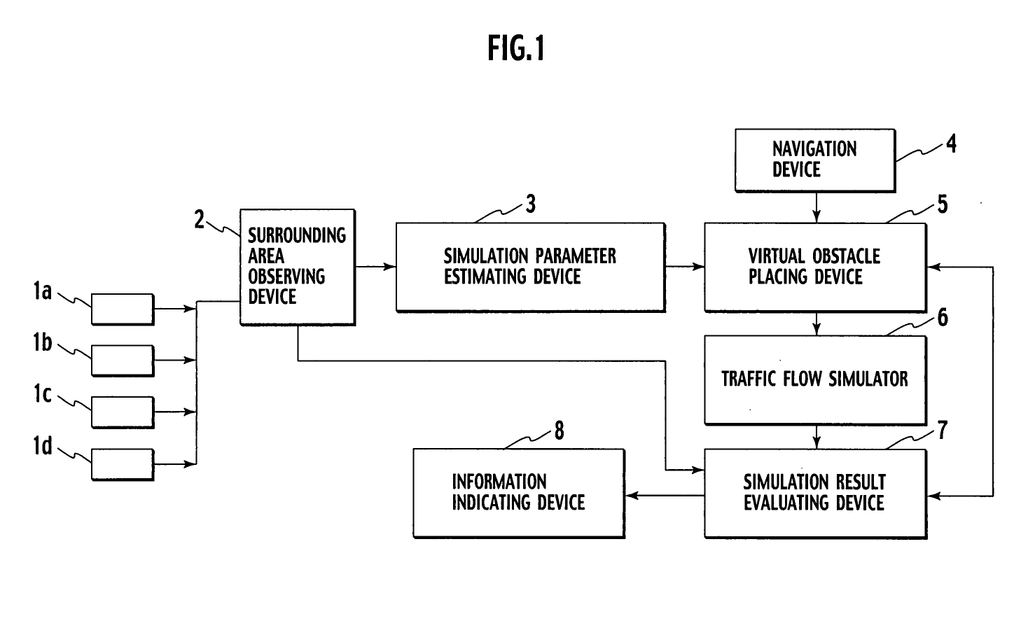

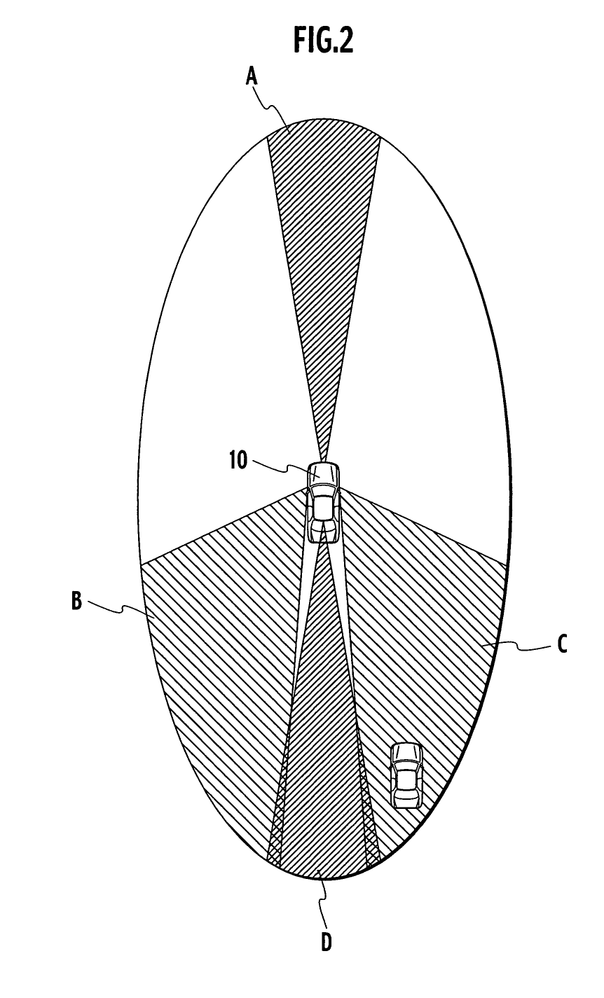

Referring now to FIG. 1, the configuration of a driving support system according to the first embodiment of the present invention is explained.

The driving support system in the first embodiment of the present invention is provided to a vehicle, and mainly comprises, as shown in FIG. 1, a surrounding area observing device 2 electrically connected to cameras 1a to 1d, a simulation parameter estimating device 3, a virtual obstacle placing device 5 electrically connected to a navigating device 4, a traffic flow simulator 6, a simulation result evaluating device 7, and an information indicating device 8 composed of an output unit such as an image or sound output unit.

In this embodiment, the cameras 1a, 1b, 1c, and 1d take images of a forward area A, a left rear side area B, a right rear side area C, and a backward area D, respectively, of a vehicle 10 that is provided with the driving support system, and then input data of the taken images to the surrounding area observing device 2. Also, the surrounding area observing device 2, the simulation parameter estimating device 3, the virtual obstacle placing device 5, the traffic flow simulator 6, and the simulation result evaluating device 7 may be configured by defining their functions with a computer program to make an information processor execute this computer program.

The cameras 1a to 1d, the surrounding area observing device 2, and the simulation parameter estimating device 3 are operable as vehicle placement detection means, parameter calculation means, and simulation parameter calculation means, respectively, according to the present invention. Furthermore, the navigating device 4 and the virtual obstacle placing device 5 are operable as road geometry estimation means and virtual obstacle placement means, respectively, according to the present invention. Moreover, the traffic flow simulator 6 and the simulation result evaluating device 7 are operable as traffic flow simulation means and traffic flow predicting means, respectively, according to the present invention.

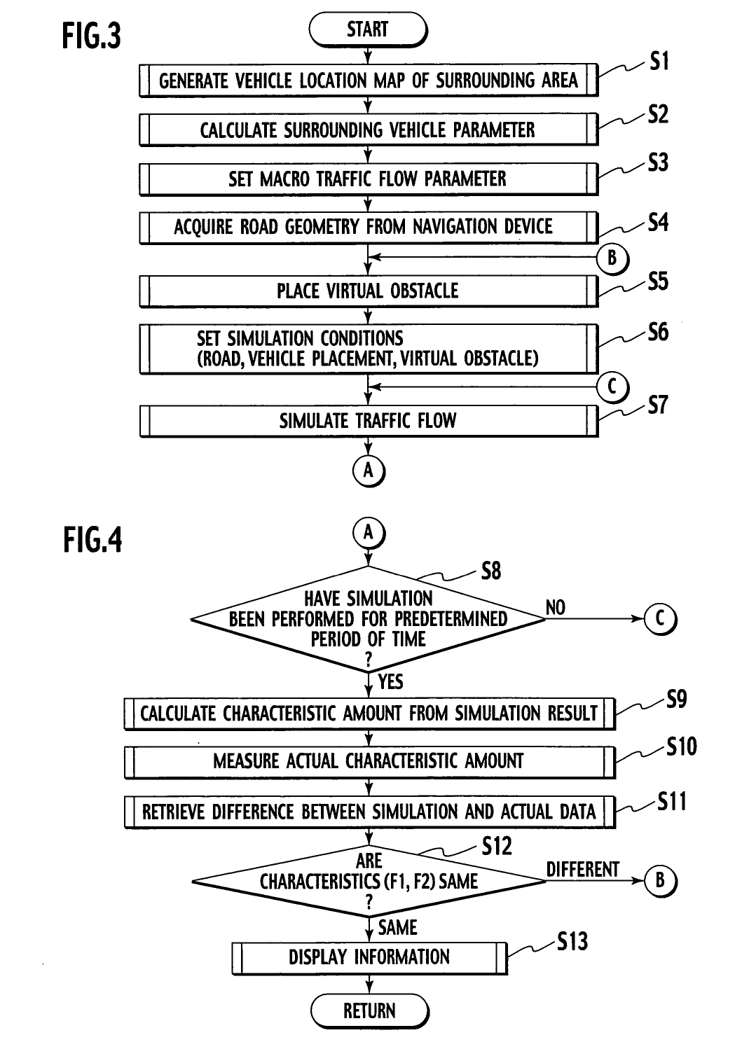

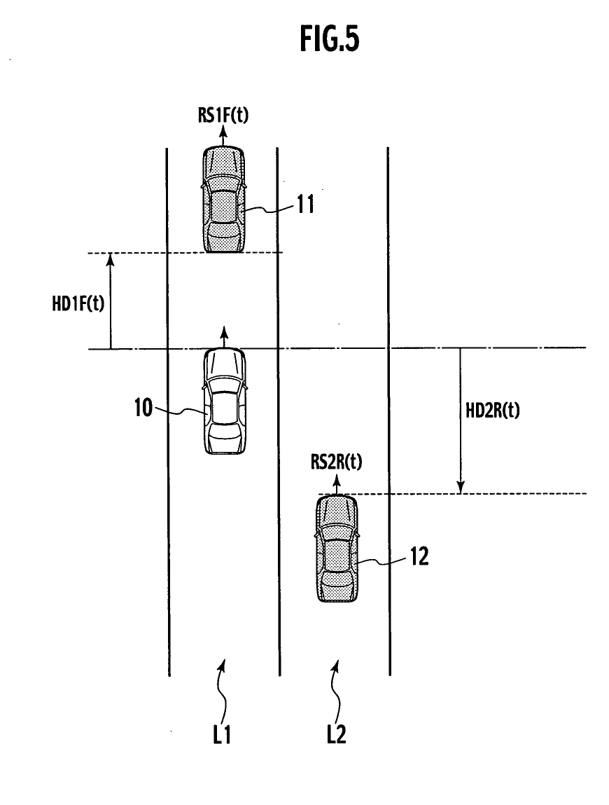

The driving support system thus configured executes driving support processing described below when the vehicle 10 starts, thereby providing a driver with information of traffic conditions in a location unobservable from the vehicle 10. With reference to the flowcharts of FIGS. 3 and 4, operations in the driving support system performed when the driving support processing is executed are now described.

The flowchart in FIG. 3 is started when the power is supplied to the components in the driving support system upon turning on an ignition switch of the vehicle 10 and thereafter the cameras 1a, 1b, 1c, and 1d input the image data of the forward area A, left rear side area B, right rear side area C, and backward area D, respectively, of the vehicle 10 to the surrounding area observing device 2. The driving support processing then proceeds to step S1.

In step S1, the surrounding area observing device 2 applies predetermined image processing to the image data inputted from the cameras 1a to 1d to generate a map of surrounding area indicating traffic conditions around the vehicle 10 as shown FIG. 5. Then, the processing in step S1 is completed, whereupon the driving support processing proceeds from step S1 to step S2.

In step S2, the surrounding area observing device 2 calculates a distance (vehicle distance) of the vehicle 10 to other vehicles around the vehicle 10 and a relative speed of the vehicle 10 with respect to other vehicles around the vehicle 10 by using the map of surrounding area generated in step S1, and then inputs the calculated vehicle distance and relative speed as a surrounding vehicle parameter to the simulation parameter estimating device 3.

More specifically, when the map of surrounding area generated in step S1 is the one shown in FIG. 5, the surrounding area observing device 2 calculates vehicle distances HD1F(t) (t:time), HD1R(t) and relative speeds RS1F(t), RS1R(t), of the vehicle 10 to other vehicles traveling on spots in front of and behind the vehicle 10 on a lane L1 (vehicle 11 in the drawing), and also calculates vehicle distances HD2F(t), HD2R(t) and relative speeds RS2F(t), RS2R(t), of the vehicle 10 to other vehicles traveling on spots diagonally in front of and behind the vehicle 10 on a lane L2 adjacent to the lane L1.

When there is no vehicle at the above spots, the surrounding area observing device 2 inputs preset, predetermined values as a value calculated for the spots to the simulation parameter estimating device 3. Specifically, when there is no vehicle traveling on the above spots, the surrounding area observing device 2 determines that a vehicle or vehicles are traveling in the vicinity of the boundary of an area observable from the vehicle 10, and thus calculates the vehicle distance and relative speed to be the distance to the boundary and 0 km/h, respectively. In step S2, the surrounding area observing device 2 also may execute processing of determining based on the calculated value whether the vehicle 10 can merge with traffic on another lane. Then, the processing in step S2 is completed, whereupon the driving support processing proceeds from step S2 to step S3.

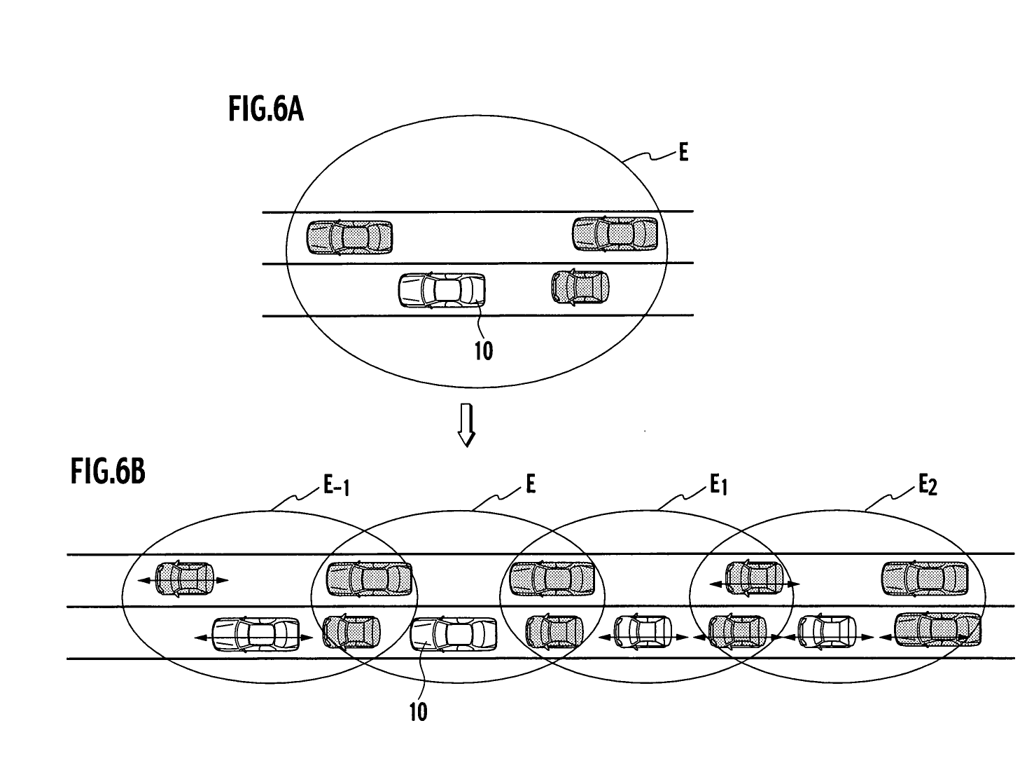

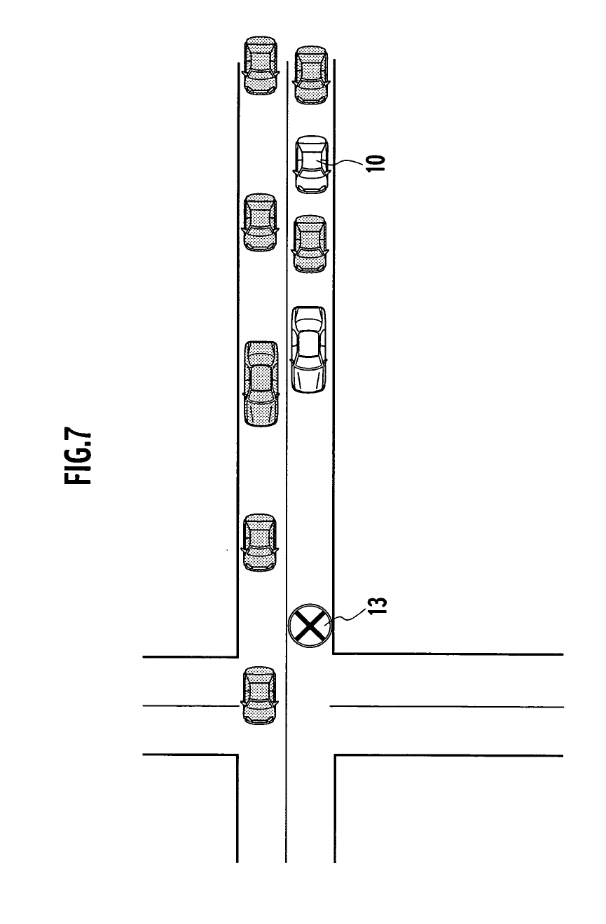

In step S3, as shown in FIG. 6B, the simulation parameter estimating device 3 sets simulation areas (E₋₁ to E₂) each of which has vehicle placement E (FIG. 6A) around the vehicle 10 that is defined by the surrounding vehicle parameters inputted from the surrounding area observing device 2 and is periodically repeated within a predetermined region to form the simulation areas, and determines an initial value for starting a traffic flow simulation (locations and speeds of vehicles present in the simulation areas) The simulation parameter estimating device 3 then inputs the determined initial value as a macro traffic flow parameter to the virtual obstacle placing device 5. Then, the processing in step S3 is completed, whereupon the driving support processing proceeds from step S3 to step S4.

Since the periodically and regularly repetitive vehicle placement E in the predetermined region is unnatural in reality, the simulation parameter estimating device 3 may preferably change the values (vehicle distance and relative speed of the vehicle) inputted from the surrounding area observing device 2, as shown by arrows in FIG. 6B, by selecting random numbers from a Gaussian distribution whose average value is the value inputted from the surrounding area observing device 2. In addition, the simulation parameter estimating device 3 may preferably set the predetermined region so that the simulation areas can range from about 1 to 2 kilometers ahead of and behind the vehicle 10.

In step S4, the virtual obstacle placing device 5 controls the navigating device 4 to acquire therefrom geometry information within the simulation areas including road geometry, lane configuration, intersection layout, and the like, and inputs the acquired geometry information to the traffic flow simulator 6. Then, the processing in step S4 is completed, whereupon the driving support processing proceeds from step S4 to step S5.

In step S5, the virtual obstacle placing device 5 places a virtual obstacle 13 within the simulation areas as shown in FIG. 7 in accordance with the geometry information acquired in step S4, and inputs information of the location and size of the virtual obstacle 13 to the traffic flow simulator 6. More specifically, the virtual obstacle placing device 5 places, as the virtual obstacle 13, a parked vehicle at a spot X meters ahead of the vehicle 10 on its driving lane or at a spot X meters ahead of the vehicle 10 on a lane adjacent to its driving lane in such a way as to block the driving lane or adjacent lane. Then, the processing in step S5 is completed, whereupon the driving support processing proceeds from step S5 to step S6.

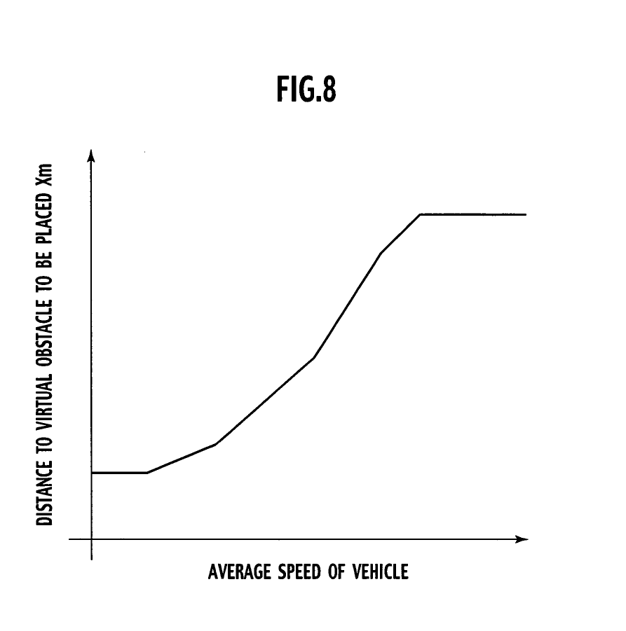

In general, when there is an obstacle near a vehicle, the average driving speed HV0(t) of the vehicle decreases, while it does not when an obstacle is far from the vehicle. Therefore, there is a high possibility that the obstacle is far from the vehicle when the average driving speed HV0(t) thereof is high, and that the obstacle is near the vehicle when the average driving speed HV0(t) is low. Accordingly, the virtual obstacle placing device 5 may preferably calculate the average driving speed HV0(t) of the vehicle, and determine a location X (meters) where the virtual obstacle 13 is to be placed in accordance with the calculated average driving speed HV0(t) by referring to a graphic chart that represents the correspondence between the vehicle's average driving speed and the obstacle location as shown in FIG. 8.

When it is, however, determined based on the information acquired from the navigating device 4 that there is an intersection, junction, or fork within a specific area around the spot X meters ahead of the vehicle 10, it is desirable for the virtual obstacle placing device 5 to place the virtual obstacle 13 at the intersection, junction, or fork. When it is also determined that there are two or more intersections, junctions, or forks within the specific area around the spot X meters ahead of the vehicle 10, the virtual obstacle placing device 5 may preferably place the virtual obstacle 13 at the respective intersections, junctions, or forks. Furthermore, when there is a fork ahead of the vehicle, it is desirable for the virtual obstacle placing device 5 to determine a ratio of vehicles running in different ways at the fork which indicates, for example, whether the fork separates all vehicles in different ways or whether the fork separates vehicles to through vehicles and left-turn vehicles, and to input the determined ratio to the traffic flow simulator 6.

In step S6, the traffic flow simulator 6 places the vehicle 10, other vehicles around the vehicle 10, and the virtual obstacle 13 on a virtual road formed based on the actual road geometry in accordance with the information inputted from the virtual obstacle placing device 5, and thereby sets simulation conditions for starting a traffic flow simulation. Then, the processing in step S6 is completed, whereupon the driving support processing proceeds from step S6 to step S7.

In step S7, the traffic flow simulator 6 executes the traffic flow simulation in accordance with the set simulation conditions. Immediately after the traffic flow simulation is started, an unnatural traffic flow is presented because the virtual obstacle 13 suddenly appears on the road at a certain time; however, as the traffic flow simulation is continued, it becomes possible to indicate a near-actual traffic flow. Then, the processing in step S7 is completed, whereupon the driving support processing proceeds from step S7 to step S8.

In step S8, the traffic flow simulator 6 determines whether it has executed the traffic flow simulation for a predetermined period of time. When the traffic flow simulator 6 does not determine that it has executed the traffic flow simulation for the predetermined period of time, the traffic flow simulator 6 returns the driving support processing from step S8 to step S7. On the other hand, when the traffic flow simulator 6 determines that it has executed the traffic flow simulation for the predetermined period of time, the traffic flow simulator 6 advances the driving support processing from step S8 to step S9. Note here that the traffic flow simulation is made faster than real-time progress, in which an actual traffic flow realized in a minute can be calculated in about one-tenth thereof. Therefore, the traffic flow simulator 6 sets the predetermined period of time depending on how many minutes (hours) in advance a traffic flow is simulated.

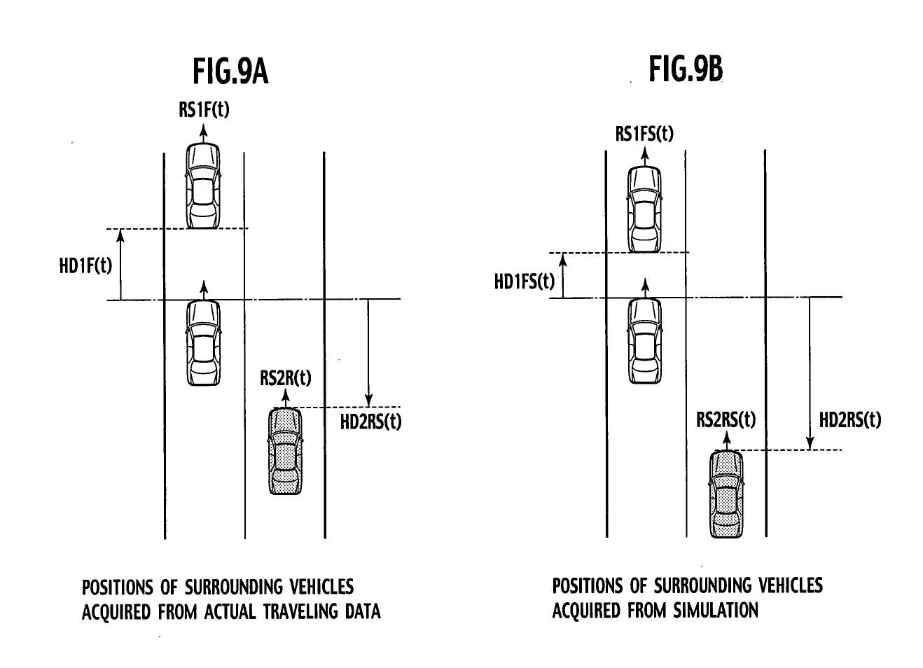

In step S9, the traffic flow simulator 6 calculates the vehicle distance and relative speed of the vehicle 10 to other vehicles around the vehicle 10 based on the virtual traffic flow provided after the traffic flow simulation is executed for the predetermined period of time, and inputs the calculated values as a virtual traffic flow characteristic amount to the simulation result evaluating device 7. As more specifically shown in FIG. 9B, the traffic flow simulator 6 calculates based on the result of the traffic flow simulation, vehicle distances HD1FS(t), HD1RS(t) and relative speeds RS1FS(t), RS1RS(t) of the vehicle 10 to other vehicles traveling in front of and behind the vehicle 10, and vehicle distances HD2FS (t), HD2RS (t) and relative speeds RS2FS (t), RS2RS(t) of the vehicle 10 to other vehicles traveling diagonally in front of and behind the vehicle 10 on a lane adjacent to the lane of the vehicle 10. Then, the processing in step S9 is completed, whereupon the driving support processing proceeds from step S9 to step S10.

In step S10, the surrounding area observing device 2 measures the vehicle distance and relative speed of the vehicle 10 to other vehicles around the vehicle 10 by applying the predetermined image processing to the image data inputted from the cameras 1a to 1d, and inputs the measured values as an actual traffic flow characteristic amount to the simulation result evaluating device 7. As more specifically shown in FIG. 9A, the surrounding area observing device 2 calculates vehicle distances HDLF(t), HDLR(t) and relative speeds RS1F(t), RS1R(t) of the vehicle 10 to other vehicles traveling in front of and behind the vehicle 10, and vehicle distances HD2F(t), HD2R(t) and relative speeds RS2F(t), RS2R(t) of the vehicle 10 to other vehicles traveling diagonally in front of and behind the vehicle 10 on a lane adjacent to the lane of the vehicle 10. Then, the processing in step S10 is completed, whereupon the driving support processing proceeds from step S10 to step S11.

In step S11, the simulation result evaluating device 7 compares the virtual traffic flow characteristic amount with the actual traffic flow characteristic amount to obtain a difference therebetween. More specifically, the simulation result evaluating device 7 calculates F-test values of F1 ((HD1FS(t), HD1RS(t), HD2FS(t), HD2RS(t)), (HD1F(t), HD1R(t), HD2F(t), HD2R(t), 0.05)) and F2 ((RS1FS(t), RS1RS(t), RS2FS(t), RS2RS(t)), (RS1F(t), RS1R(t) RS2F(t), RS2R(t), 0.05)) for vehicle distances and relative speeds, respectively, in the light of their variances. Then, the processing in step S11 is completed, whereupon the driving support processing proceeds from step S11 to step S12.

In step S12, the simulation result evaluating device 7 determines whether the virtual traffic flow characteristic amount is the same as the actual traffic flow characteristic amount. More specifically, when differences in variations are found in at least one of the F-test values F1 and F2, the simulation result evaluating device 7 determines that the virtual traffic flow characteristic amount is different from the actual traffic flow characteristic amount. When differences in variations of the both F-test values F1 and F2 are disregarded, the simulation result evaluating device 7 determines that the virtual traffic flow characteristic amount is the same as the actual traffic flow characteristic amount.

When the virtual traffic flow characteristic amount is determined to be different from the actual traffic flow characteristic amount, the simulation result evaluating device 7 returns the driving support processing from step S12 to step S5. When the virtual traffic flow characteristic amount is determined to be the same as the actual traffic flow characteristic amount, the simulation result evaluating device 7 advances the driving support processing from step S12 to step S13. Note here that, when the driving support processing is returned to step S5, the simulation result evaluating device 7 directs the virtual obstacle placing device 5 to place the virtual obstacle 13 at a location different from the previous one.

In step S13, the simulation result evaluating device 7 determines that there is an actual obstacle at the location where the virtual obstacle 13 is placed, and controls the information indicating device 8 to provide a guidance for supporting a driver making decisions of his or her driving behavior, such as “Please watch out ahead. A lane change may be required”. Then, the processing in step S12 is completed, whereupon the driving support processing returns from step S13 to step S1.

In the above driving support processing, the simulation result evaluating device 7 returns the driving support processing from step S12 directly to step S5 when it determines that the virtual traffic flow characteristic amount is different from the actual traffic flow characteristic amount; however, when differences in variations are recognized in only one of the F-test values F1 and F2, it is also possible that the simulation result evaluating device 7 determines that there is probably an actual obstacle at the location where the virtual obstacle 13 is placed, and then controls the information indicating device 8 to output a guidance such as “please watch out ahead”, before returning the driving support processing to step S5.

As is clear from the above description, according to the driving support system in the first embodiment of the present invention, the surrounding area observing device 2 detects a traffic flow around the vehicle 10, the traffic flow simulator 6 simulates a virtual traffic flow based on the detected traffic flow, and the simulation result evaluating device 7 predicts an approaching traffic flow around the vehicle 10 based on the simulation result, so that traffic conditions in a location unobservable from the vehicle 10 can be presented to a driver with a simpler system configuration. This also allows the driver to determine his or her driving behavior with sufficient time, thereby generating smooth traffic flows and realizing safe driving.

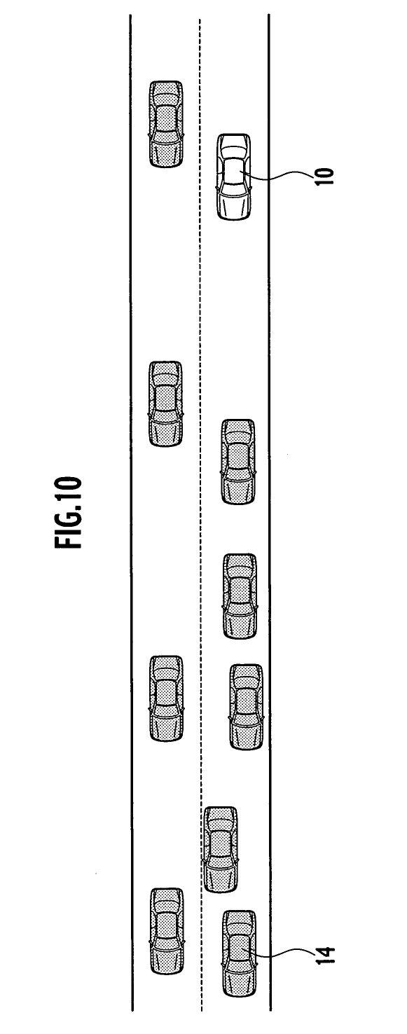

Furthermore, according to the driving support system in the first embodiment of the present invention, the virtual obstacle placing device 5 places the virtual obstacle 13 on a road for which a traffic flow is simulated, and the traffic flow simulator 6 simulates a virtual traffic flow in consideration of the virtual obstacle 13. As specifically shown in FIG. 10, it is assumed that a parked vehicle 14 which is 1,000 meters ahead of the vehicle 10 causes a traffic trouble. In this case, since the parked vehicle 14 is far ahead of the vehicle 10, the driver of the vehicle 10 cannot perceive the occurrence of the traffic trouble.

Advantageously, the driving support system in the first embodiment of the present invention simulates a virtual traffic flow in which the parked vehicle 14 is placed 1,000 meters ahead of the vehicle 10. According to such a configuration, an approaching traffic flow can be predicted including the parked vehicle 14 in an area unobservable from the vehicle 10. In addition, the driver can recognize in advance the presence of the traffic trouble, so that his or her wrong operation can be prevented when actually reacting to the traffic trouble. Furthermore, any person inexperienced in driving can easily recognize the presence of the traffic trouble.

Moreover, according to the driving support system in the first embodiment of the present invention, the simulation result evaluating device 7 determines whether the simulation result is appropriate, by comparison between the virtual traffic flow simulated by the traffic flow simulator 6 and the actual traffic flow detected by the surrounding area observing device 2, thereby enabling accurate prediction of traffic flows including the obstacle 13 in the area unobservable from the vehicle 10.

### Second Embodiment

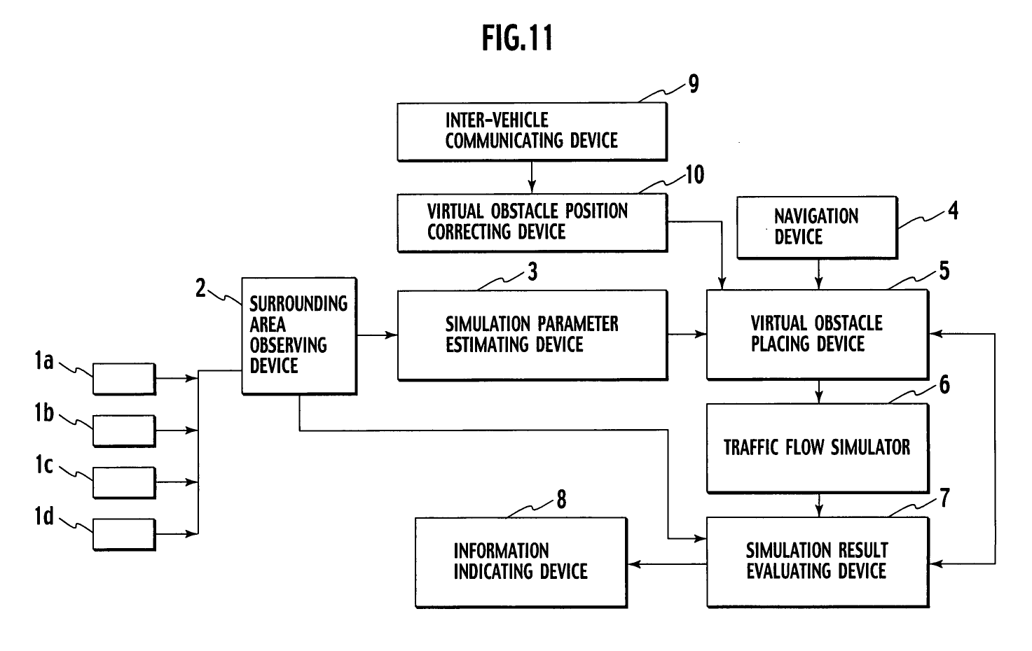

With reference to FIG. 11, the configuration of a driving support system according to the second embodiment of the present invention will be described.

The driving support system according to the second embodiment of the present invention has the configuration of the first embodiment and additionally comprises an inter-vehicle communicating device 9 and a virtual obstacle position correcting device 10, as shown in FIG. 11. In the following paragraphs, descriptions will be given of only for the inter-vehicle communicating device 9 and the virtual obstacle position correcting device 10, and descriptions for other components will be omitted.

The inter-vehicle communicating device 9 is operable as communication means according to the present invention, which exchanges various information with the inter-vehicle communication devices provided to other vehicles around a vehicle (subject vehicle). The virtual obstacle position correcting device 10 acquires via the inter-vehicle communicating device 9, information of the position of a virtual obstacle that is set by the virtual obstacle placing device 5 provided to other vehicles around the subject vehicle, and corrects the position of a virtual obstacle that is set by the virtual obstacle placing device 5 in the subject vehicle by referring to the acquired information.

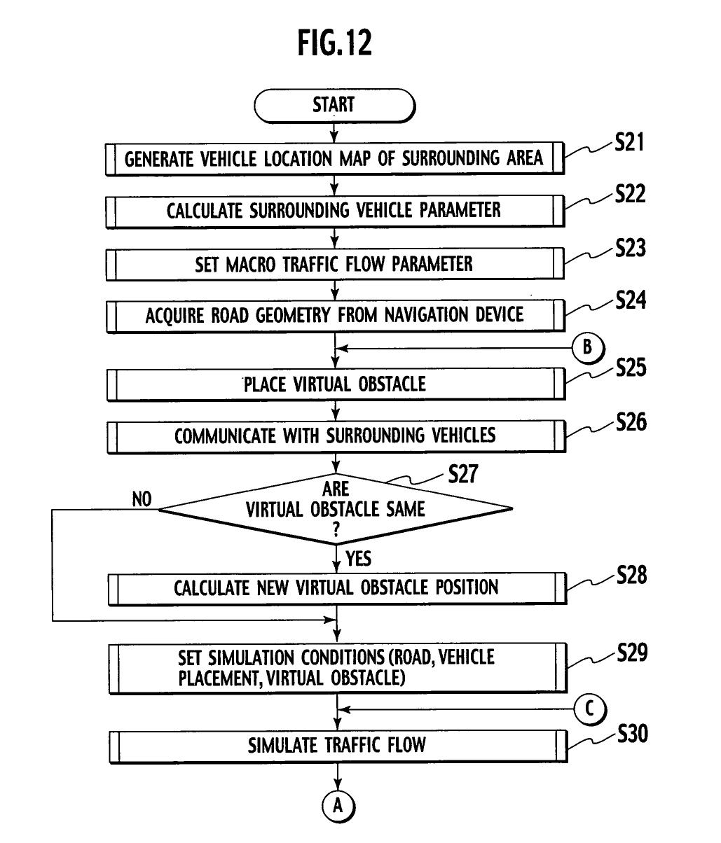

The driving support system thus configured works toward improving the accuracy of a traffic flow simulation and reducing in convergence time of the traffic flow simulation by executing driving support processing described below. Referring to the flowchart in FIG. 12, operations in the driving support system performed when the driving support processing is executed will be described below.

The flowchart in FIG. 12 is started when the power is supplied to the components in the driving support system upon turning on an ignition switch of the vehicle 10 and thereafter the cameras 1a, 1b, 1c, and 1d input image data of the forward area A, left rear side area B, right rear side area C, and backward area D, respectively, of the vehicle 10 to the surrounding area observing device 2. The driving support processing then proceeds to step S21. The processing in steps S21 to S25 and the processing in steps S29 and S30 are identical with the processing in steps S1 to S5 and the processing in steps S6 and S7, respectively, so the descriptions therefor will be omitted, and only the processing in steps S26 to S28 will be explained in the following.

In step S26, the virtual obstacle position correcting device 10 communicates via the inter-vehicle communicating device 9 with the one provided to other vehicles around the subject vehicle, and thereby acquires information of the position of the virtual obstacle that is set by the virtual obstacle placing device provided to other vehicles. The information of the virtual obstacle position may be acquired from one or more vehicles, and the increased number of other vehicles from which the information of the virtual obstacle position is acquired enhances the effect of the improvement of traffic flow simulation accuracy and of the reduction in convergence time. Then, the processing in step S26 is completed, whereupon the driving support processing proceeds from step S26 to step S27.

In step S27, the virtual obstacle position correcting device 10 estimates whether a virtual obstacle set in step S25 is the same as the virtual obstacle set by other vehicles around the subject vehicle, by referring to the information acquired in step S26. More specifically, the virtual obstacle position correcting device 10 calculates a distance between the position of the virtual obstacle set in step S25 (X1, Y1) and the position of the virtual obstacle set by other vehicles around the subject vehicle (X2, Y2), and presumes that both the virtual obstacles are the same when the calculated distance is smaller than a predetermined value.

When it is presumed that the virtual obstacle set in step S25 and the virtual obstacle set by other vehicles around the subject vehicle are different from each other, the virtual obstacle position correcting device 10 advances the driving support processing to step S29. On the other hand, when it is presumed that both the virtual obstacles are the same, the virtual obstacle position correcting device 10 advances the driving support processing to step S28.

In step S28, the virtual obstacle position correcting device 10 corrects the position of the virtual obstacle set in step S25. More specifically, the virtual obstacle position correcting device 10 sets a weight W1 corresponding to a difference between the virtual traffic flow characteristic amount and the actual traffic flow characteristic amount in accordance with the result of the processing previously executed in step S11, and acquires a weight W2 set by other vehicles around the subject vehicle via the inter-vehicle communicating device 9.

The virtual obstacle position correcting device 10 calculates a new virtual obstacle position (Xn, Yn) from the following equations of Xn=(X1·W1+X2/W2)/(W1+W2) and Yn=(Y1·W1+Y2/W2)/(W1+W2), and inputs the information of the calculated new virtual obstacle position to the traffic flow simulator 6 via the virtual obstacle placing device 5. More specifically, the virtual obstacle position correcting device 10 sets weights W1 and W2 such that they represent the consistency between the current traffic flow and the virtual traffic flow based on the virtual obstacle position in the subject vehicle and the consistency between the current traffic flow and the virtual traffic flow based on the virtual obstacle position in other vehicles, respectively, and sets a virtual obstacle position obtained by proportional division using the set weights W1 and W2 as a new position of the virtual obstacle for the next traffic flow simulation. Then, the processing in step S28 is completed, whereupon the driving support processing proceeds from step S28 to step S29.

As is clear from the above description, according to the driving support system in the second embodiment of the present invention, the virtual obstacle position correcting device 10 acquires via the inter-vehicle communicating device 9, the information of the virtual obstacle position set by the virtual obstacle placing device 5 in other vehicles around the subject vehicle, and corrects the virtual traffic flow set by the subject vehicle based on the acquired information. This means that the driving support system according to the second embodiment of the present invention shares information with the driving support system provided to other vehicles via the inter-vehicle communicating device 9, thereby achieving more accurate traffic flow simulation.

Furthermore, according to the driving support system in the second embodiment of the present invention, the virtual obstacle position correcting device 10 corrects the virtual obstacle position set by the subject vehicle by referring to the information of the virtual obstacle position acquired from other vehicles, thereby achieving more accurate traffic flow simulation and leading to reduction in convergence time of the traffic flow simulation.

Moreover, according to the driving support system in the second embodiment of the present invention, the virtual obstacle position correcting device 10 corrects the virtual obstacle position in consideration of the consistency between the current traffic flow and the virtual traffic flow based on the virtual obstacle position of other vehicles, thereby also achieving more accurate traffic flow simulation and leading to reduction in convergence time of the traffic flow simulation.

It is also allowable that the inter-vehicle communicating device 9 may send the information of the virtual obstacle position corrected by the virtual obstacle position correcting device 10 to the inter-vehicle communicating device in other vehicles. With this configuration, since the corrected virtual obstacle position information can be used in other vehicles, the improvement in the traffic flow simulation accuracy as well as the reduction in convergence time can be achieved also in the driving support system in other vehicles.

### Third Embodiment

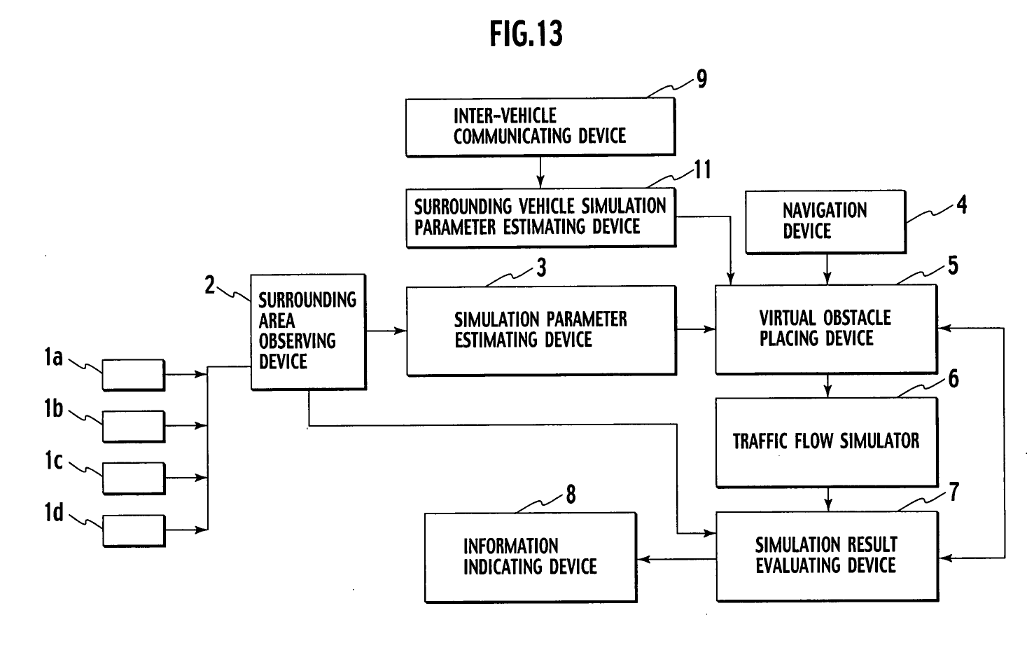

Referring next to FIG. 13, the configuration of a driving support system according to the third embodiment of the present invention will be described.

The driving support system according to the third embodiment of the present invention has, as shown in FIG. 13, the configuration in which the virtual obstacle position correcting device 10 of the driving support system in the second embodiment is replaced with a surrounding vehicle simulation parameter estimating device 11. In the following paragraphs, descriptions will be given of only the surrounding vehicle simulation parameter estimating device 11, and descriptions for other components will be omitted.

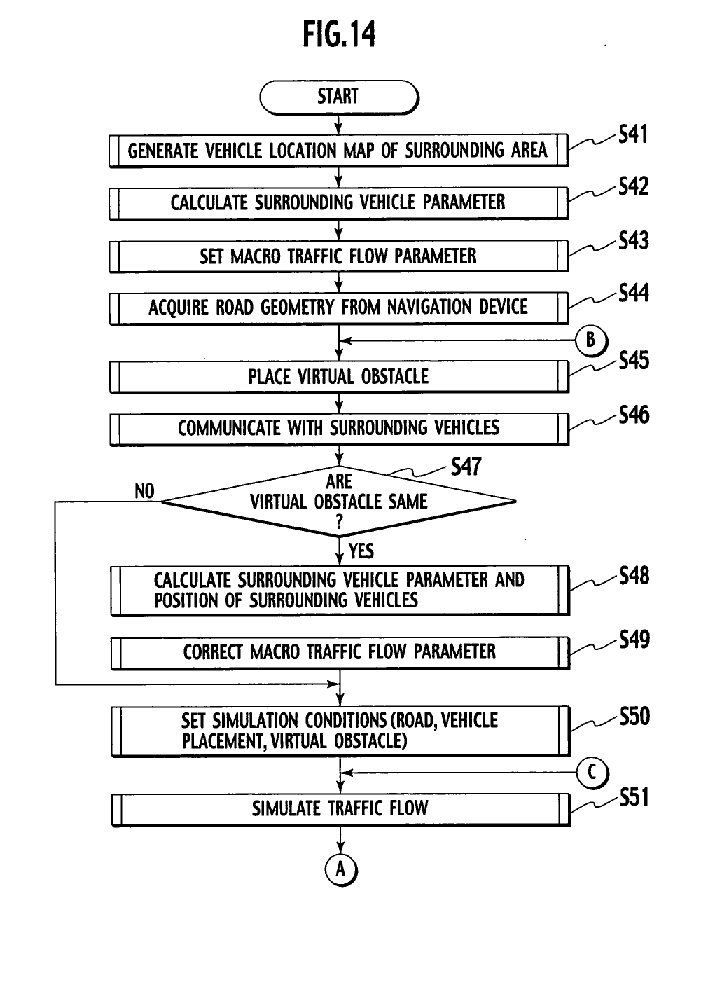

The surrounding vehicle simulation parameter estimating device 11 acquires via the inter-vehicle communicating device 9, information of the surrounding vehicle parameter calculated by the surrounding area observing device provided to other vehicles around the subject vehicle, and then inputs the acquired information to the simulation parameter estimating device 3. The driving support system thus configured works toward improving the accuracy of the traffic flow simulation and reducing the convergence time of the traffic flow simulation by executing driving support processing described below. With reference to the flowchart in FIG. 14, operations in the driving support system performed when the driving support processing is executed will be explained.

The flowchart in FIG. 14 is started when the power is supplied to the components in the driving support system upon turning on an ignition switch of the vehicle 10 and thereafter the cameras 1a, 1b, 1c, and 1d input image data of the forward area A, left rear side area B, right rear side area C, and backward area D, respectively, of the vehicle 10 to the surrounding area observing device 2. The driving support processing then proceeds to step S41. The processing in step S41 to step S45 and the processing in steps S50 and S51 are the same as the processing in step S1 to step S5 and the processing in steps S6 and S7, respectively, of FIG. 3, so the descriptions therefor will be omitted and only the processing in step S46 to step S49 will be explained.

In step S46, the surrounding vehicle simulation parameter estimating device 11 communicates via the inter-vehicle communicating device 9 with the one provided to other vehicles around the subject vehicle thereby to acquire information of the virtual obstacle position and surrounding vehicle parameter that are set by the virtual obstacle placing device and surrounding are a observing device provided to other vehicles. The information of the virtual obstacle position and surrounding vehicle parameter may be acquired from one or more vehicles. Then, the processing in step S46 is completed, whereupon the driving support processing proceeds from step S46 to step S47.

In step S47, the surrounding vehicle simulation parameter estimating device 11 estimates whether a virtual obstacle set in step S45 and the virtual obstacle set by other vehicles around the subject vehicle are the same, by referring to the information acquired in step S46. When it is estimated that the both are different virtual obstacles, the surrounding vehicle simulation parameter estimating device 11 advances the driving support processing to step S50. On the other hand, when it is estimated that the virtual obstacle set in step S45 and the virtual obstacle set by other vehicles around the subject vehicle are the same, the surrounding vehicle simulation parameter estimating device 11 advances the driving support processing to step S48.

In step S48, the surrounding vehicle simulation parameter estimating device 11 calculates the position information and surrounding vehicle parameter of other vehicles with reference to the information acquired in step S46, and inputs the calculated position information and surrounding vehicle parameter of other vehicles to the surrounding vehicle simulation parameter estimating device 11. Then, the processing in step S48 is completed, whereupon the driving support processing proceeds from step S48 to step S49.

In step S49, the simulation parameter estimating device 3 estimates a macro traffic flow parameter by the use of the position information and surrounding vehicle parameter of other vehicles that are inputted from the surrounding vehicle simulation parameter estimating device 11, and inputs the estimated macro traffic flow parameter to the traffic flow simulator 6. Specifically, the simulation parameter estimating device 3 sets simulation areas each of which has vehicle placement around the subject vehicle that is defined by the surrounding vehicle parameter inputted from the surrounding area observing device of the subject vehicle and is periodically repeated within a predetermined region to form the simulation areas, and then corrects the position of other vehicles traveling in the simulation areas by referring to the position information and surrounding vehicle parameter calculated in step S48. The simulation parameter estimating device 3 then sets the position and speed of vehicles in the simulation areas as the macro traffic flow parameters. Then, the processing in step S49 is completed, whereupon the driving support processing proceeds from step S49 to step S50.

As is clear from the above description, according to the driving support system in the third embodiment of the present invention, the surrounding vehicle simulation parameter estimating device 11 acquires the information of the surrounding vehicle parameter calculated by the surrounding area observing device provided to other vehicles around the subject vehicle via the inter-vehicle communicating device 9, and the simulation parameter estimating device 3 corrects the macro traffic flow parameter based on the acquired information, thereby achieving more accurate traffic flow simulation.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

The entire content of a Patent Application No. TOKUGAN 2003-420837 with a filing date of Dec. 18, 2003, and a Patent Application No. TOKUGAN 2004-266762 with a filing date of Sep. 14, 2004, is hereby incorporated by reference.

1. A driving support system provided to a vehicle for supporting a driver in making a decision of his or her driving behavior, comprising:
traffic flow detection means for detecting a current traffic flow around a subject vehicle;
traffic flow simulation means for simulating a virtual traffic flow based on the traffic flow detected by the traffic flow detection means; and
traffic flow predicting means for predicting an approaching traffic flow around the subject vehicle based on the virtual traffic flow simulated by the traffic flow simulation means.

2. A driving support system provided to a vehicle for supporting a driver in making a decision of his or her driving behavior, comprising:
a traffic flow detecting unit that detects a current traffic flow around a subject vehicle;
a traffic flow simulating unit that simulates a virtual traffic flow based on the traffic flow detected by the traffic flow detecting unit; and
a traffic flow predicting unit that predicts an approaching traffic flow around the subject vehicle based on the virtual traffic flow simulated by the traffic flow simulating unit.

3. The driving support system according to claim 2, further comprising:
a virtual obstacle placing unit that sets an arbitrary virtual obstacle within an area where the traffic flow simulating unit simulates the virtual traffic flow, wherein
the traffic flow simulating unit simulates the virtual traffic flow in consideration of the arbitrary virtual obstacle set by the virtual obstacle placing unit.

4. The driving support system according to claim 2, wherein the traffic flow predicting unit determines whether the virtual traffic flow simulated by the traffic flow simulating unit is appropriate, by comparing the virtual traffic flow with the current traffic flow around the subject vehicle.

5. The driving support system according to claim 4, wherein the traffic flow predicting unit determines that there is an actual obstacle at the position where the virtual obstacle placing device sets the virtual obstacle, when the virtual traffic flow simulated by the traffic flow simulating unit is the same as the current traffic flow around the subject vehicle.

6. The driving support system according to claim 5, further comprising:
an information indicating unit that notices a driver of the presence of the actual obstacle when the traffic flow predicting unit determines that there is the actual obstacle at the position where the virtual obstacle placing unit sets the virtual obstacle.

7. The driving support system according to claim 4, wherein the traffic flow predicting unit calculates a characteristic amount of the respective virtual traffic flow and current traffic flow around the subject vehicle, and compares the virtual traffic flow with the current traffic flow around the subject vehicle through statistical testing of the calculated characteristic amount.

8. The driving support system according to claim 3, wherein the virtual obstacle placing unit determines the position where the virtual obstacle is set, in accordance with an average traveling speed of the subject vehicle.

9. The driving support system according to claim 2, wherein the traffic flow detecting unit includes a vehicle placement detecting unit that detects current vehicle placement around the subject vehicle, a parameter calculating unit that calculates a parameter representing the current vehicle placement around the subject vehicle based on the vehicle placement detected by the vehicle placement detecting unit, and a simulation parameter calculating unit that calculates a simulation parameter for executing the traffic flow simulation by using the parameter calculated by the parameter calculating unit.

10. The driving support system according to claim 2, further comprising:
a road geometry estimating unit that estimates road geometry around the subject vehicle, wherein
the traffic flow simulation unit simulates the virtual traffic flow in accordance with the road geometry estimated by the road geometry estimating unit.

11. The driving support system according to claim 2, further comprising:
a communicating unit that communicates with other vehicles around the subject vehicle; and
a correcting unit that acquires information from the driving support system provided to the other vehicles around the subject vehicle via the communicating unit, and corrects the simulated virtual traffic flow in consideration of the acquired information.

12. The driving support system according to claim 11, wherein the correcting unit acquires via the communicating unit, information of the position of the virtual obstacle that is set by the virtual obstacle placing unit provided to the other vehicles around the subject vehicle, and corrects the position of the arbitrary virtual obstacle that is set by the virtual obstacle placing unit of the subject vehicle in accordance with the acquired information.

13. The driving support system according to claim 12, wherein the correcting unit corrects the position of the arbitrary virtual obstacle in consideration of the consistency between the current traffic flow and the virtual traffic flow based on the position of the arbitrary virtual obstacle set by the other vehicles.

14. The driving support system according to claim 12, wherein the correcting unit sends the information of the position of the virtual obstacle to the other vehicles around the subject vehicle via the communicating unit.

15. The driving support system according to claim 11, wherein the correcting unit receives via the communicating unit, the parameter calculated by the parameter calculating unit provided to the other vehicles around the subject vehicle, and corrects the parameter calculated by the parameter calculating unit of the subject vehicle in accordance with the received parameter.

16. A driving support program executed by a computer in a vehicle for supporting a driver in making a decision of his or her driving behavior, the program comprising the processes of:
detecting a current traffic flow around a subject vehicle;
simulating a virtual traffic flow based on the detected current traffic flow; and
predicting an approaching traffic flow around the subject vehicle based on the simulated virtual traffic flow.
